(19) United States
(12) Patent Application Publication
(10) Pub. No.: US 2026/0169153 A1
(43) Pub. Date: Jun. 18, 2026

(54) Decoding Radio Frequency Signal Reflections into Object Embedding for Contextual Triggers

(71) Applicant: Google LLC, Mountain View, CA (US)

(72) Inventor: Dongeek Shin, San Jose, CA (US)

(73) Assignee: Google LLC, Mountain View, CA (US)

(21) Appl. No.: 19/122,933

(22) PCT Filed: Jun. 23, 2023
(86) PCT No.: PCT/US2023/068992

§ 371 Date: Apr. 21, 2025

(51) Int. Cl. G01S 13/88; G01S 7/41; G01S 13/02

(52) U.S. Cl. CPC G01S 13/88; G01S 7/412; G01S 7/417; G01S 13/0209

(57) ABSTRACT

This document describes systems and techniques directed at decoding radio frequency signal reflections into object embeddings for contextual triggers. In aspects, a computing device having a radar system and a radar manager is configured to transmit a transmission waveform signal and receive a reflection waveform signal that includes a version of the transmission waveform signal that is reflected by an object. Based on the reflection waveform signal, the radar manager generates an object embedding associated with the object and compares the object embedding to a previous object embedding to provide a comparison result. The radar manager determines, based on the comparison result, that the object embedding and the previous object embedding are associated with a same object. The radar manager communicates the determination to the computing device which, based on the determination, triggers a contextual event.

### BACKGROUND

Computing devices have become ubiquitous sensors for the world around us. Those that include cameras can visually identify faces of individuals, species of animals, and even names of numerous plant types. Those that include microphones can audibly identify voices of individuals, songs, and even translate languages in real time. Those that include Global Positioning System (GPS) radios can provide real-time location tracking and direction planning.

However, some of these capabilities may not occur without a user input, can cause privacy concerns, and may not identify specific objects. Cameras of computing devices, for example, typically do not operate without user input. Further, cameras cannot operate continuously due to privacy concerns and, in mobile computing devices, cause battery drain. Even further, cameras may be sufficient at detecting or recognizing object categories (e.g., dogs, cats), but they may not be accurate enough to identify a specific object within an object category (e.g., a user's dog, a user's cat).

### SUMMARY

This document describes systems and techniques directed at decoding radio frequency (RF) signal reflections into object embeddings for contextual triggers. In aspects, a computing device (e.g., smartphone, tablet) having a radar system and a radar manager is configured to transmit a transmission waveform signal and receive a reflection waveform signal that includes a version of the transmission waveform signal that is reflected by an object. The radar system may include an antenna array and a transceiver that includes at least one transmit channel and at least one receive channel, each respectively coupled to antenna elements of the antenna array. The transmit channel and respective antenna elements may be used for transmitting the transmission waveform signal, which may be a coded waveform (e.g., fixed, known). Similarly, the receive channel and respective antenna elements may be used for receiving the reflection waveform signal.

Based on the reflection waveform signal, the radar manager may generate an object embedding associated with the object. The reflection waveform signal may be sampled and correlated with stored code of the transmission waveform signal to generate a channel impulse response (CIR). The CIR, the reflection waveform signal, or a combination of both may be provided as input to an embedding model (e.g., as a result of a neural network trained offline) that is stored in memory of the computing device to generate the object embedding. Any one of a variety of loss functions (e.g., triplet loss) may be used in generating the object embedding. The radar manager may compare the object embedding to a previous object embedding to provide a comparison result. The previous object embedding may have been generated by the radar manager during an out-of-the-box initialization process where a user may generate various object embeddings for a variety of objects, including personal objects, in a camera-like fashion (e.g., point-and-shoot). The comparison result may be a Boolean result (e.g., indicating a match or a non-match), a ranked result (e.g., how likely a match may be), or the like.

The radar manager may determine, based on the comparison result, that the object embedding and the previous object embedding are associated with a same object. For example, a user may calibrate the radar manager with a scan of a front door to his home during an initialization process. Later, the user may exit his home, shut the front door, and scan the front door to indicate to the radar manager that he is leaving his home. The radar manager may communicate the determination to the computing device which, based on the determination, may trigger a contextual event. Continuing with the present example, the user may have a smart home application with automatic locks and a security system set to arm when he leaves his home. Rather than accessing the application and doing so manually, the user may set the contextual event to be a locking of his automatic locks and arming of his security system. In this way, the user may simply scan his front door when he leaves his home to lock the locks and arm the security system (e.g., trigger contextual events).

The details of one or more implementations are set forth in the accompanying Drawings and the following Detailed Description. Other features and advantages will be apparent from the Detailed Description, the Drawings, and the Claims. This Summary is provided to introduce subject matter that is further described in the Detailed Description. Accordingly, a reader should not consider the Summary to describe essential features or to threshold the scope of the claimed subject matter.

### BRIEF DESCRIPTION OF THE DRAWINGS

The details of one or more aspects of decoding radio frequency (RF) signal reflections into object embeddings for contextual triggers are described in this document with reference to the following Drawings. The use of same numbers in different instances throughout the Drawings may indicate similar features or components.

FIG. 1 illustrates an example environment of a computing device having a radar system and a radar manager configured to decode RF signal reflections into object embeddings for contextual triggers;

FIG. 2 illustrates an example implementation of the computing device from FIG. 1, which is configured to provide the radar manager;

FIG. 3A illustrates a plan view of an example implementation of a computing device having a radar system;

FIG. 3B illustrates a partial view of the example implementation of the radar system from FIG. 3A in more detail;

FIG. 4 illustrates various examples of relative power spectral densities and radio frequencies that a radar manager may utilize;

FIG. 5A illustrates an example implementation of a computing device transmitting a transmission waveform signal;

FIG. 5B illustrates the example implementation of the computing device from FIG. 5A receiving a reflection waveform signal;

FIG. 6 illustrates an example method of a radar manager generating an object embedding based on a reflected RF signal;

FIG. 7 illustrates an example method of a radar manager triggering a contextual event based on a reflected RF signal; and

FIG. 8 illustrates an example method for decoding RF signal reflections into object embeddings for contextual triggers.

### DETAILED DESCRIPTION

### Overview

Computing devices (e.g., smartphones) often include a plurality of sensors to facilitate various functionalities and improve user experiences. Image sensors (e.g., cameras) enable computing devices to capture photos and videos. Microphones enable computing devices to capture audio and enable users to call friends and family. Cameras can further be utilized by computing devices to identify objects visually, including various animals and individual faces. Microphones can further be utilized by computing devices to identify songs and receive voice commands.

However, cameras and microphones can have certain limitations. For example, recording video or audio continuously can result in significant battery drain for mobile computing devices. Further, constant video or audio recording can cause privacy concerns, especially in protected spaces like restrooms or locker rooms. As another example, although cameras may enable computing devices to identify objects visually, they do so usually as groups (e.g., cats, dogs), rather than specific objects (e.g., a user's cat, a user's dog) within groups. Further, many of these functionalities are active, requiring direct attention or input from users, making them sub-optimal for passive operations like passive object identification.

This document describes systems and techniques directed at decoding RF signal reflections into object embeddings for contextual triggers. The disclosed systems and techniques may address shortcomings of sensors that require direct attention or input from users, sensors that can cause significant battery drain in mobile computing devices, and sensors that can cause privacy concerns in protected spaces. The conflict between these shortcomings may be addressed by the disclosed systems and techniques, which may provide passive object identification for triggering contextual events, improving user experiences.

The following discussion describes operating environments, techniques that may be employed in the operating environments, example devices, and example methods. Although systems and techniques for decoding RF signal reflections into object embeddings for contextual triggers are described, it is to be understood that the subject of the appended Claims is not necessarily limited to the specific features or methods described. Rather, the specific features and methods are disclosed as example implementations, reference to which is made by way of example only.

### Example Operating Environment

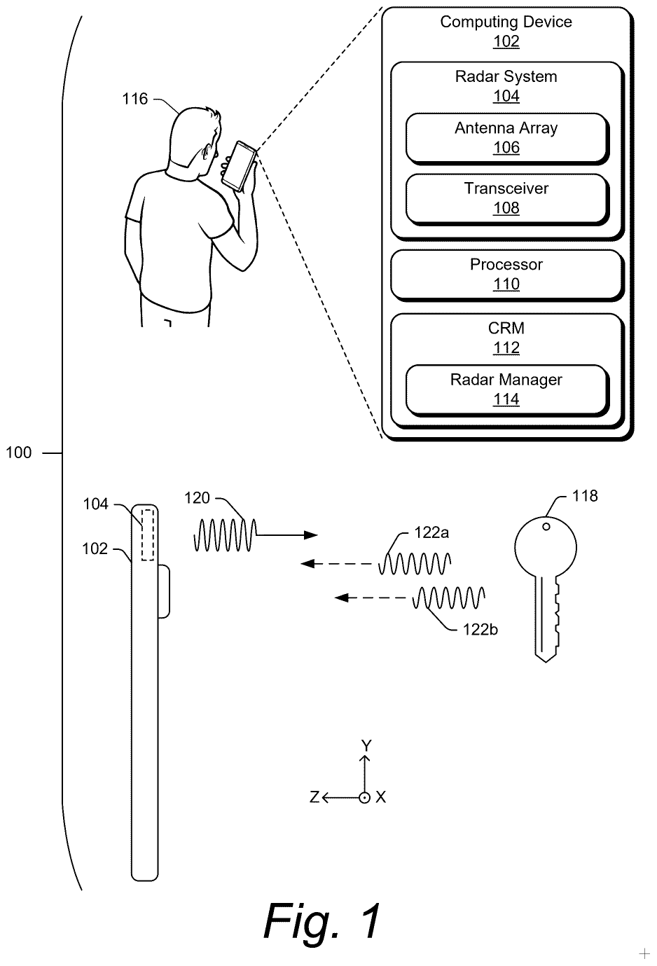

FIG. 1 illustrates an example environment 100 of a computing device 102 having a radar system 104 and a radar manager 114 configured to decode RF signal reflections into object embeddings for contextual triggers. As illustrated, the computing device 102 further includes a processor 110 and computer-readable media 112 (CRM 112). The radar system 104 may include an antenna array 106 and a transceiver 108. The antenna array 106 may include one or more antenna elements. The transceiver 108 may include one or more transmit channels and one or more receive channels respectively coupled to elements of the antenna array 106. The transceiver 108 may be configured to use any one of a variety of frequencies or power spectral densities among the RF portion of the electromagnetic spectrum. For example, the transceiver 108 may be configured to use ultra-wideband (UWB) signals, which include a bandwidth of approximately 500 megahertz (MHz) centered around a center frequency. The center frequency can include any frequency from approximately 3.1 gigahertz (GHz) to 10.5 GHz. Further, the transceiver 108 may be configured to transmit such signals at lower power spectral densities so that the radar system 104 is afforded additional benefits. The additional benefits can include operating the radar system 104 in a continuous mode without draining a battery (not illustrated), experiencing decreased in-band interference from other narrowband RF signals, and being more secure than alternative power spectral densities as the low power spectral densities make the signals difficult to detect.

The processor 110 can be any appropriate single-core or multi-core processor, including a central processing unit (CPU), a graphics processing unit (GPU), an advanced reduced instruction set compute machine (ARM), or the like. The CRM 112 can include memory media (e.g., dynamic random-access memory (DRAM)) and storage media (e.g., solid-state drives (SSDs)). The CRM 112 can include various computer-readable instructions that are executable by the processor 110 to provide at least some of the functionalities described herein. The computer-readable instructions can include various applications, an operating system (OS), and so forth. FIG. 1 illustrates that the CRM 112 includes computer-readable instructions of a radar manager 114 configured to decode RF signal reflections into object embeddings for contextual triggers.

FIG. 1 further illustrates a user 116 of the computing device 102, who wishes to utilize the radar manager 114 to scan a car key 118. To scan the car key 118, the user 116 (not shown) orients the computing device 102 so that the radar system 104 is aimed towards the car key 118. During an initialization or out-of-the-box experience for the computing device 102 or the radar manager 114 thereof, the user 116 may provide a user input (e.g., a touch input) to scan the car key 118 for a first time.

Responsive to the user input, the radar manager 114 transmits a transmission waveform signal 120 (e.g., utilizing the radar system 104) directed at the car key 118 along a negative Z-axis, as illustrated. The transmission waveform signal 120 may be, as described above, a UWB signal or another appropriate RF signal. The transmission waveform signal 120 may be temporally constrained (e.g., restricted to less than two nanoseconds (ns)) and include various RF pulses of various frequencies included in the UWB signal spectrum. The transmission waveform signal 120 may be optimized so that it includes a known code (e.g., sequence of pulses of known frequencies).

The transmission waveform signal 120 may be reflected by the car key 118 into a reflection waveform signal that includes a version of the transmission waveform signal 120. This means, for example, that an amplitude, phase, and/or frequency of the reflection waveform signal may differ from the transmission waveform signal. In this example environment 100, the reflection waveform signal includes a first reflection waveform signal 122a and a second reflection waveform signal 122b. The first and second reflection waveform signals 122a and 122b may represent surface and sub-surface reflections of the transmission waveform signal 120 off the car key 118. Additionally or alternatively, the first and second reflection waveform signals 122a and 122b can represent surface reflections off the car key 118 from different and respective locations of the car key 118.

The radar manager 114 receives the first and second reflection waveform signals 122a and 122b along a positive Z-axis, as illustrated. The radar manager 114 may generate, based on the received signals, an object embedding associated with the car key 118. The object embedding may be a numerical, rotationally-invariant representation of the received signals and can be generated by an embedding model. The embedding model can, for example, be stored as computer-readable instructions on the CRM 112 as part of the radar manager 114. The embedding model may be a result of an embedding network, or other appropriate neural network, that is trained offline on various reflection waveform signals associated with various respective objects as input data. The embedding network may use any one of a variety of loss functions (e.g., triplet loss) in order to generate an optimal embedding model as output data.

In generating the object embedding, the radar manager 114 may pre-process the reflection waveform signals before generating a final object embedding. For example, the radar manager 114 may sample portions of the first reflection waveform signal 122a and/or the second reflection waveform signal 122b to correlate to the transmission waveform signal 120. The radar manager 114 may generate, based on the correlations, a channel impulse response (CIR), which may be stored (e.g., on the CRM 112) as the object embedding. The CIR may be a mathematical representation of the reflection waveform signal that results from the transmission waveform signal (e.g., the impulse) being reflected by the car key 118. The radar manager 114 may further pre-process the reflection waveform signals by passing the CIR through a log-scaling function that can improve a dynamic range of the CIR to be more amenable to upstream neural network processing. The log-scaling function may convert the mathematical representation of the reflection waveform included in the CIR from a linear domain to a logarithmic domain. The radar manager 114 may do so because, for example, many data sets (e.g., semiconductor degradation, planetary orbital periods or radii) are better analyzed in the logarithmic domain. As another example, some distributions of data may be heavily biased to a high side or a low side (e.g., compared to the mean or median) in the linear domain but are normally distributed in the logarithmic domain. Once finalized, the object embedding associated with the car key 118 may be saved in a lookup table (LUT), for example, stored as computer-readable data on the CRM 112.

Although not shown in FIG. 1, the computing device 102 may include a car application that is associated with a car of the user 116. The user 116 may indicate to the radar manager 114 that subsequent scans of the car key 118 should trigger a contextual event. For example, the user 116 may program the car application to start the car when the car key 118 is subsequently scanned. As another example, the computing device 102 may be set to operate in a vehicle-friendly operation mode as a result of subsequent scans of the car key 118. Further, because the radar system 104 may be configured to utilize UWB signals of low power spectral densities, the radar manager 114 may operate in a continuous mode, not requiring explicit input from the user 116. Even further, because UWB and other appropriate RF signals can penetrate materials, the car key 118 does not necessarily need to be in direct line-of-site with the computing device 102. For example, the user 116 may passively scan the car key 118 by positioning the computing device 102 so that the radar system 104 is oriented towards the car key 118 within a pants pocket of the user 116.

In this way, the radar manager 114 decodes RF signal reflections into object embeddings for contextual triggers. By so doing, the radar manager 114 enables the user 116 to passively trigger contextual events (e.g., starting the car, entering the vehicle-friendly operation mode of the computing device 102) utilizing the radar system 104, the antenna array 106, and the transceiver 108. Further, the radar manager 114 enables the user 116 to benefit from this functionality passively and without concern for privacy while causing decreased battery drain.

### Example Devices

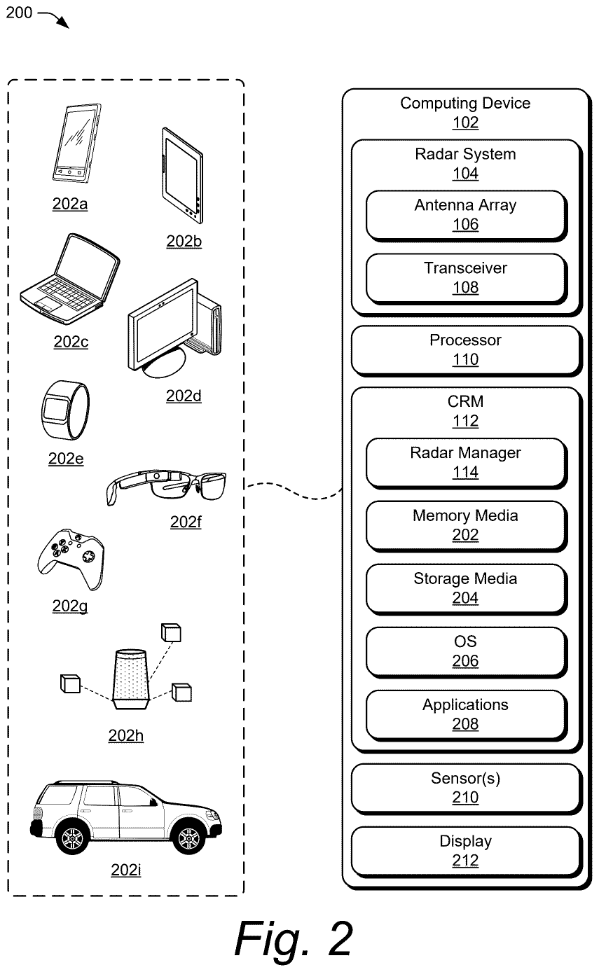

In more detail, FIG. 2 illustrates an example implementation 200 of the computing device 102 from FIG. 1, which is configured to provide the radar manager 114. The computing device 102 is illustrated as various example devices. As non-limiting examples, the computing device 102 can be a smartphone 202a, a tablet 202b, a laptop 202c, a desktop 202d, a smartwatch 202e, a pair of smart glasses 202f, a game controller 202g, a smart home speaker 202h, or a vehicle 202i. Although not illustrated, the computing device 102 may also be implemented as a health monitoring device, a personal media device, a drone, a home appliance, a security system or device thereof, a digital photo frame, and so forth. The computing device 102 can be wearable, non-wearable but mobile, or relatively immobile. Further, the computing device 102 can be used with or embedded within many computing devices or peripherals (e.g., vehicles, personal computers). The computing device 102 may also include additional interfaces or components omitted from FIG. 2.

FIG. 2 illustrates that the computing device 102 includes various components described with reference to FIG. 1, including the radar system 104, the antenna array 106, the transceiver 108, the processor 110, the CRM 112, and the radar manager 114. FIG. 2 further illustrates that the CRM 112 may include memory media 202 and storage media 204. The memory media 202 may include one or more non-transitory storage devices, including random-access memory (RAM) or DRAM. The storage media 204 may include one or more transitory storage devices, including an SSD or a magnetic spinning hard disk drive (HDD). The CRM 112 may further include an operating system 206 (OS 206) and applications 208, which may be stored as computer-readable instructions on the CRM 112. The processors 110 can execute the computer-readable instructions on the CRM 112 to provide some or all of the functionalities described herein.

FIG. 2 also illustrates that the computing device 102 includes one or more sensors 210 and a display 212. The sensors 210 can include image sensors, microphones, accelerometers, barometers, ambient light sensors, thermometers, and so forth. The display 212 can be realized as any one of a variety of display technologies. Some display technologies include liquid crystal displays (LCDs), light-emitting diode (LED) displays, organic LED (OLED) display, twisted nematic displays, in-plane switching displays, and the like. Although not shown, the display 212 may be paired with a touchscreen or another appropriate touch input device so that a user (e.g., the user 116 of FIG. 1) may provide touch inputs (e.g., during the initialization process of the radar manager 114 described with reference to FIG. 1).

In implementations, the radar manager 114 can include one or more integrated circuits (ICs), a system-on-a-chip (SOC), a secure key store, hardware embedded with firmware, a printed circuit board (PCB) with various hardware components, or any combination thereof. As described herein, the radar manager 114 may include one or more components of the computing device 102, as illustrated in FIG. 1 and FIG. 2, configured to decode RF signal reflections into object embeddings for contextual triggers. In other implementations, the radar manager 114 may be implemented as the computing device 102.

Although not shown, the computing device 102 can also input/output (I/O) ports, a system bus, an interconnect, or another data transfer system that couples with various components of or within the computing device 102. As an example, the I/O ports can enable the computing device 102 to interact with other devices or users through peripheral devices, transmitting any combination of digital signals and/or analog signals via wired manners (e.g., ethernet) or wireless manners (e.g., radio). The I/O ports may include any combination of internal or external ports, including universal serial bus ports, audio ports, video ports, and so forth. Various peripheral devices (e.g., human input devices, external CRM, speakers, displays) may be coupled with the I/O ports.

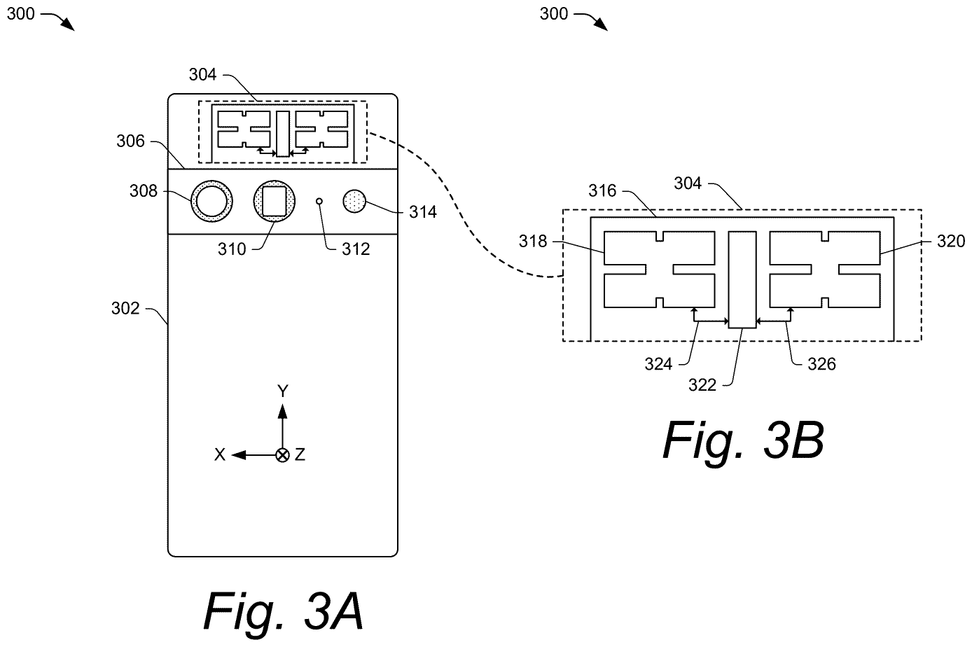

FIG. 3A illustrates a plan view of an example implementation 300 of a computing device 302 having a radar system 304. The computing device 302 and the radar system 304 are similar to the computing device 102 and the radar system 104 illustrated in FIGS. 1 and 2 and described above, except as detailed below. Thus, although not shown, the computing device 102 can include one or more processors, CRM that store computer-readable instructions (e.g. radar manager 114 of FIG. 1 or 2), an OS (e.g., OS 206 of FIG. 2), and applications (e.g., applications 208 of FIG. 2). The radar system 304 likewise includes an antenna array and a transceiver, which are illustrated in FIG. 3B and described below.

As illustrated in FIG. 3A, the example implementation 300 of the computing device 302 includes the radar system 304 in a top center position within a housing (not shown) of the computing device 302. Although a top center position is shown, the radar system 304 can be located anywhere on or in the computing device 302. FIG. 3A further illustrates that the computing device 302 includes a camera module 306. The camera module 306 may include a first camera 308, a second camera 310, a microphone 312, and an illuminator 314 (e.g., a “flash”). The first camera 308 may be a wide-angle camera and the second camera 310 may be a high-zoom camera. The microphone 312 can be any appropriate microphone, including dynamic microphones, condenser microphones, ribbon microphones, and so forth. The first camera 308, the second camera 310, and the microphone 312 are examples of additional sensors that the computing device 302 may include. The illuminator 314 can be any appropriate flash, including an LED flash.

FIG. 3B illustrates a partial view of the radar system 304 from FIG. 3A in more detail. The radar system 304 may be implemented on a main logic board 316 (MLB 316) or another appropriate PCB, including a motherboard and/or daughterboard. The radar system 304 may further include an antenna array, which includes a first antenna 318 and a second antenna 320. The radar system 304 may also include a transceiver 322. The first antenna 318, the second antenna 320, and the transceiver 322 may be coupled (e.g., by solder, electrically, physically) to the MLB 316.

FIG. 3B also illustrates that the first and second antennas 318 and 320 are coupled to the transceiver 322 via a first channel 324 and a second channel 326, respectively. The first channel 324 and the second channel 326 may be realized as one or more appropriate single-bit or multi-bit buses. Further, the first and second channels 324 and 326 may be configured as transmit channels, receive channels, or both. As an example, the first antenna 318 and the first channel 324 may be a transmit antenna and a transmit channel. Accordingly, the second antenna 320 and the second channel 326 may be a receive antenna and a receive channel. Alternatively, a configuration of the antennas and channels may be reversed. Additionally or alternatively, both the first and second antennas 318 and 320, and the respective first and second channels 324 and 326 may be transceiver antennas and channels. The radar system 304 and the components thereof may be configured to transmit and receive specific power spectral densities and frequencies of RF signals.

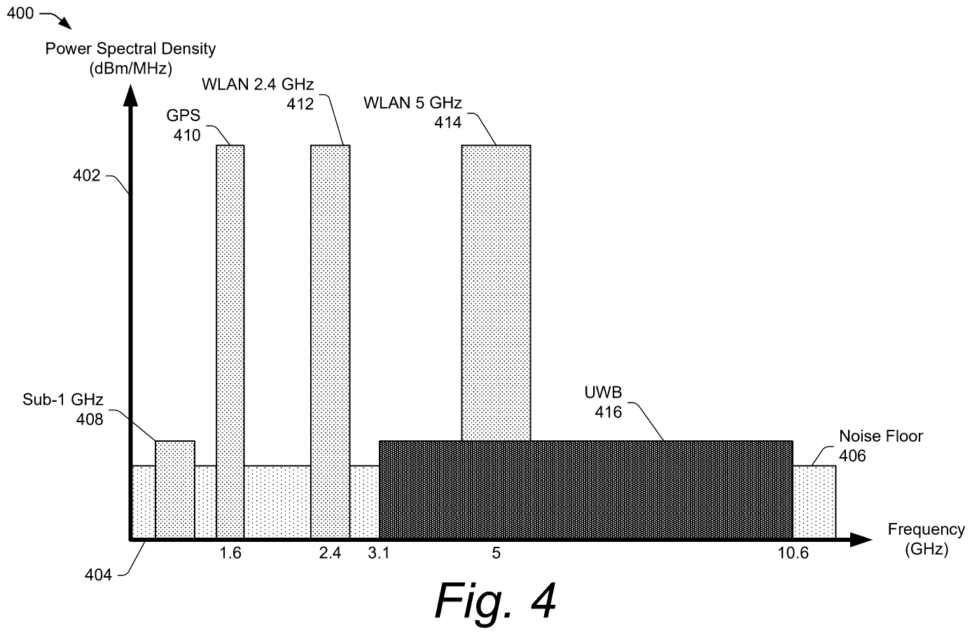

FIG. 4 illustrates an example plot 400 of relative power spectral density versus frequency that a radar system may utilize. The radar system is similar to the radar system 104 illustrated in FIGS. 1 and 2, and the radar system 304 illustrated in FIGS. 3A and 3B, which are described above, except as detailed below. Accordingly, the radar system may include an antenna array, a transceiver, and may be configured to transmit and receive RF signals of one or more frequencies and power spectral densities.

The example plot 400 includes power spectral density, commonly measured in decibel-milliwatts per megahertz (dBm/MHz), on a Y-axis 402 versus frequency, commonly measured in gigahertz (GHz), on an X-axis 404. Specific power spectral density values are omitted from FIG. 4 for the sake of simplicity. Example frequencies are labeled along the frequency X-axis 404. Further, relative shapes and sizes illustrated are for descriptive purposes only and should not be construed as quantitative values.

The example plot 400 includes a noise floor 406 that various RF signals must exceed in terms of relative power spectral density in order to be received and interpreted appropriately by computing devices. FIG. 4 also illustrates various RF bands of power spectral densities above the noise floor 406. The various RF bands include a first band 408, a second band 410, a third band 412, and a fourth band 414.

As examples, the first band 408 may be a sub-1 GHz band, such as the Industrial Scientific Medical Band (ISM), which is an unlicensed band for industrial, scientific, and medical use. The sub-1 GHz band may be utilized for short-distance transmission by various consumer electronics, including garage door openers, televisions, remote control (RC) cars, and the like. The second band 410 may be a Global Positioning System (GPS) band, which may be utilized for long-distance communication between GPS satellites and GPS-enabled devices (e.g., the computing device 102 of FIG. 1). The third band 412 may be a 2.4 GHz wireless local area network (WLAN) band utilized at user homes for WLAN functionality and various applications that may require longer range, but slower speed, wireless communication. The fourth band 414 may be a 5 GHz WLAN band utilized similarly to the second band 412, but for home WLAN applications that may require higher speed, but shorter range, wireless communication.

Lastly, FIG. 4 illustrates fifth band 416, which is significantly wider than the first through the fourth bands 408 through 414. Additionally, compared to the second through the fourth bands 410 through 414, the fifth band 416 utilizes a significantly lower power spectral density. The fifth band may be an ultra-wideband (UWB) band configured for short-range, low-power wireless communication. The UWB band may enable multiple RF channels within the UWB band that can have large bandwidths, for example, 500 MHz centered around a center frequency. The center frequency may include any frequency from approximately 3.1 GHz to 10.6 GHz. The large bandwidth channels and the large range of center frequencies enable devices (e.g., computing device 102 of FIGS. 1 and 2, computing device 302 of FIG. 3) to perform accurate real-time movement tracking, line-of-site (LoS) calculations, and precise localization in non-LoS scenarios. Further, the low power spectral density enables UWB devices to operate in a continuous mode without concern for battery drain or interfering with other wireless bands (e.g., first band 408, third band 412). The lower power spectral density also benefits UWB devices from a security perspective, as the low power makes UWB communication difficult to detect and/or intercept. The fifth band 416, therefore, may be an optimal choice for providing a radar manager (e.g., radar manager 114) that utilizes a radar system (e.g., radar system 104) configured to decode RF signal reflections into object embeddings for contextual triggers.

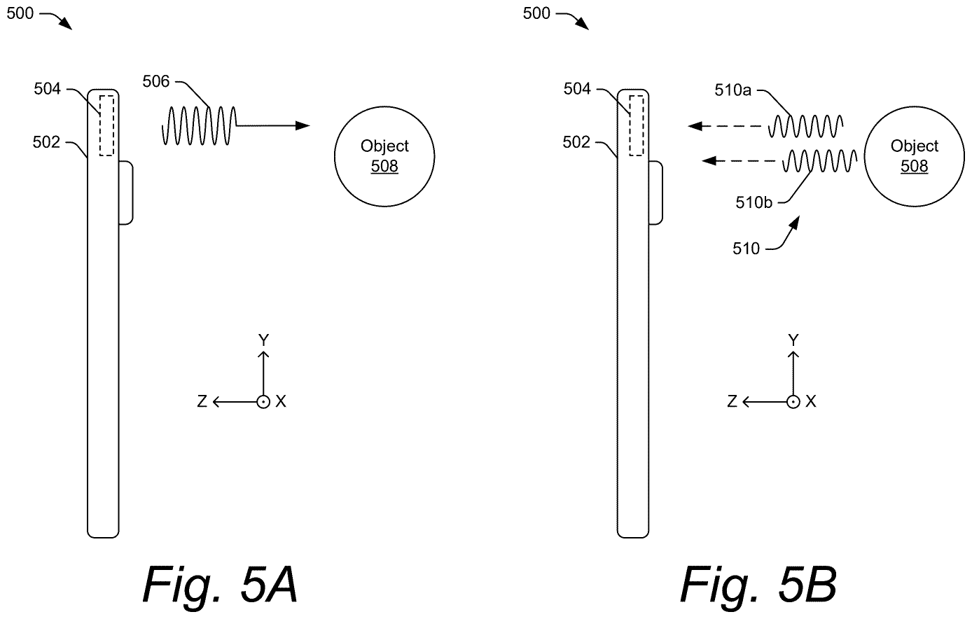

FIG. 5A illustrates an example implementation 500 of a computing device 502 transmitting a transmission waveform signal 506. The computing device 502 is similar to the computing devices 102 and 302 illustrated in FIGS. 1, 2, and 3, respectively, and described above, except as detailed below. Thus, the computing device 502 has a radar system 504, which includes an antenna array and a transceiver (not shown), and a radar manager (not shown) configured to transmit the transmission waveform signal 506.

As illustrated, the radar manager transmits, using the radar system 504, the transmission waveform signal 506 in a negative Z-axis and towards an object 508. The transmission waveform signal 506 may have a center frequency of 7 GHz, for example, and a bandwidth of 500 MHz. The transmission waveform signal 506 thus may utilize the UWB (e.g., fifth band 416 of FIG. 4) described above. Further, the transmission waveform signal 506 may be a coded signal, such that it includes a predetermined number of pulses of a certain frequency and duration of time. Continuing with the present example, the predetermined number (e.g., five, six, 10 or more) of temporally constrained pulses (e.g., tenths of nanosecond (ns), one ns, three ns) of frequencies proximate to the center frequency of 7 GHz and within the 500 MHz bandwidth. That is, the frequencies may include 6.7 GHz, 7 GHz, 7.2 GHz, and so forth. The object 508 can be any object, including personal objects of a user (e.g., the car key 118, a front door of a home, a keyboard, a watch, a pet) and commercial objects (e.g., cash registers, item scanners).

FIG. 5B illustrates the example implementation 500 of the computing device 502 from FIG. 5A receiving a reflection waveform signal 510. The reflection waveform signal 510 includes a version of the transmission waveform signal 506 of FIG. 5A that is reflected by the object 508. The reflection waveform signal 510 can include one or more surface reflections and/or one or more sub-surface reflection because RF signals can pass through some materials. As illustrated, the reflection waveform signal includes a first reflection 510a and a second reflection 510b. As an example, the object 508 may be an apple and thus the first reflection 510a may be a surface reflection off the skin of the apple and the second reflection 510b may be a sub-surface reflection off a seed of the apple. As another example, the first and second reflections 510a and 510b may both be surface reflections off the skin of the apple but from different locations (e.g., one more proximate to the computing device 502).

The radar manager of the computing device 502 may receive the reflection waveform signal 510 using the radar system 504 and components thereof. The radar manager may generate an object embedding associated with the object 508 based on the reflection waveform signal 510. The radar manager may further compare the object embedding to previous object embeddings to determine a comparison result and trigger a contextual event. The comparison may include comparing the object embedding to a previous object embedding saved in a lookup table (LUT) that a user (e.g., user 116) may populate during an initialization or out-of-the-box experience associated with the radar manager.

### Example Method

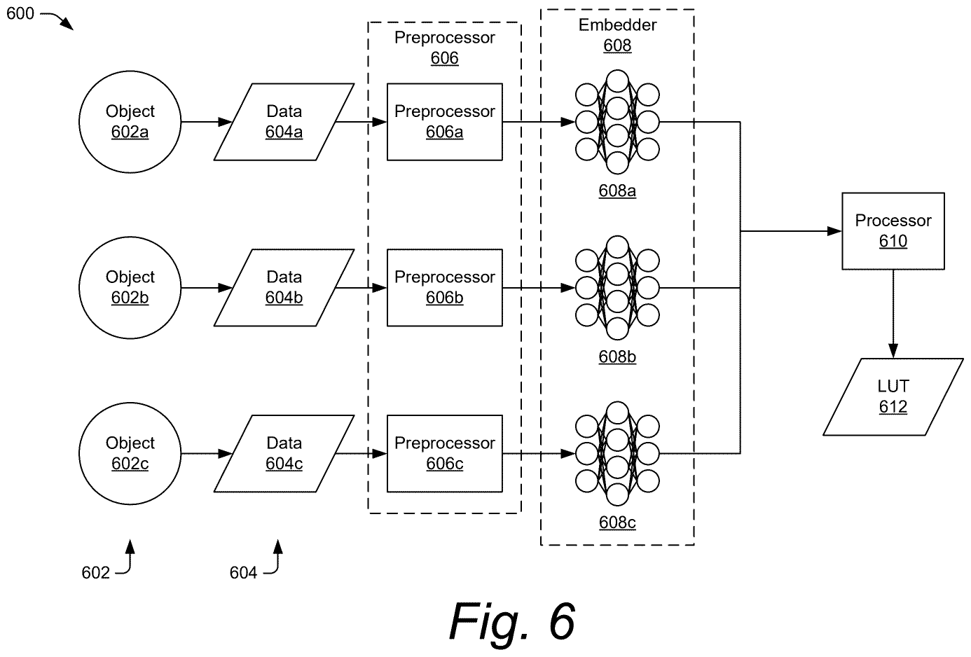

FIG. 6 illustrates an example method 600 of a radar manager generating object embeddings associated with various objects to populate a LUT 612. The radar manager is similar to the radar managers illustrated previously and described above, except as detailed below. Thus, the radar manager may be included as computer-readable instructions on CRM (e.g., CRM 112 of FIGS. 1 and 2) of a computing device (e.g., computing device 102 of FIGS. 1 and 2, computing device 502 of FIG. 5). Further, the radar manager may utilize a radar system (e.g., radar system 504 of FIG. 5) and may be configured to decode RF signals into object embeddings for contextual triggers.

As illustrated, FIG. 6 includes a first object 602a, a second object 602b, and a third object 602c. The objects 602 may be any one of a variety of objects that a user may scan, using the radar manager, during an initialization process for the radar manager. The term “scan” may refer to transmitting a transmission waveform signal and receiving a reflection waveform signal that includes a version of transmission waveform signal that is reflected off an object. Said differently, the term “scan” may be thought of as taking a photo of an object in the RF domain, rather than the visible domain, of the electromagnetic spectrum. As examples, the objects 602 can be a front or back door of a home of the user, a garage door, a cat, a dog, a water bottle, a piece of gym equipment, a piece of clothing or footwear, a hand, a foot, and so forth.

Once the user scans the first object 602a, the second object 602b, and the third object 602b, the radar manager may receive respective reflection waveform signals as data 604 associated with the objects 602. The data 604 can include any appropriate data (e.g., numerical values) associated with the reflection waveform signals of the various objects 602. The data 604 may be numerical values that represent a raw frequency, amplitude, and/or phase of the reflection waveform signal. Alternatively, the data 604 may be numerical values that represent a difference in frequency, amplitude, and/or phase of the reflection waveform signal compared to the transmission waveform signal. In this example, the data 604 includes first data 604a associated with the first object 602a, second data 604b associated with the second object 602b, and third data 604c associated with the third object 602c. The data 604 may be channel impulse responses (CIRs) for the respective reflection waveform signals of the objects 602. The CIRs may include a sample of the respective reflection waveforms signals that are correlated with the transmission waveform signal, which is known and fixed (e.g., coded, predetermined). This means that the transmission waveform signal may include specific frequencies, phases, amplitudes, and durations, regardless of an object that reflects the transmission waveform signal.

Further illustrated in FIG. 6 is a preprocessor 606, which may include a first preprocessor 606a, a second preprocessor 606b, and a third preprocessor 606c. The preprocessors 606a through 606c may be unique cores within the preprocessor 606, unique threads that the preprocessor 606 operates on, or altogether separate preprocessors. The preprocessor 606 and cores thereof can be realized as a processor (e.g., processor 110 of FIG. 1) of a computing device (e.g., computing device 102 of FIG. 1). The preprocessor 606 may be configured to take the CIRs of the various objects 602a through 602c as inputs and provide CIRs with improved dynamic range of the CIRs as outputs. The preprocessor 606 may do so via a log-scaling operation.

FIG. 6 also illustrates an embedder 608 that may include a first embedder 608a, a second embedder 608b, and a third embedder 608c. Similar to the preprocessors 606a through 606c, the embedders 608a through 608c may be realized as instances of the embedder 608, separate embedders altogether, a multi-core embedder, and so forth. The embedder 608 may utilize an embedding model generated by an embedding network, or other appropriate neural network, that is trained offline. The offline training of the embedding network may include providing various reflection waveform signals associated with various objects as input data to the embedding network. The embedding network may utilize one of a variety of loss functions (e.g., triplet loss, Euclidian distance, L2-squared distance) to generate the embedding model as output data. Alternatively or additionally, the embedding model may be based on physical transformations (e.g., rotations, translations, scaling). The embedding model may then be stored as, for example, computer-readable instructions on a CRM of a computing device for use by a radar manager to decode RF signal reflections into object embeddings for contextual triggers.

The embedders 608a through 608c may utilize the embedding model to generate object embeddings for the objects 602a through 602c, respectively, based on respective, pre-processed reflection waveform signals. The object embeddings may be provided to a processor 610, which can be any appropriate processor, including a single-core or a multi-core CPU or GPU. The processor 610 may minimize translations or other physical transformations for the object embeddings. The processor 610 may, additionally or alternatively, post-process the object embeddings so that they are rotationally invariant, numerical representations. The processor 610 may further use a loss function (e.g., Euclidean loss, triplet loss) to do so.

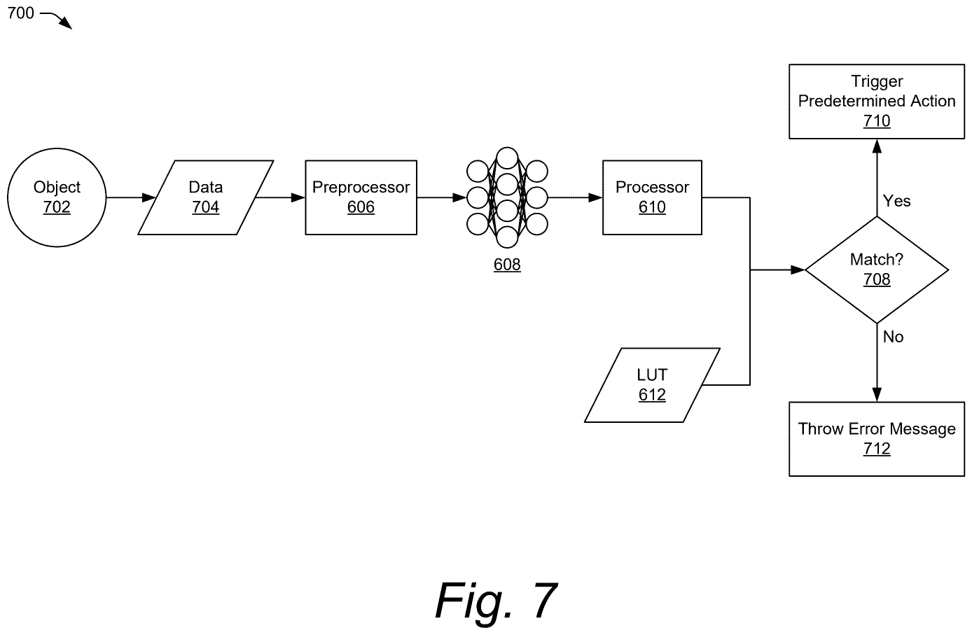

Further, the processor 610 may organize the object embeddings associated with the objects 602 into a LUT 612. The LUT 612 may be stored as computer-readable media on CRM (e.g., CRM 112 of FIGS. 1 and 2) of a computing device (e.g., computing device 102 of FIGS. 1 and 2, computing device 502 of FIG. 5). The LUT 612 may be referenced by the radar manager in comparing real-time object embeddings to previous object embeddings that are stored in the LUT 612. An example of a real-time object embedding comparison is detailed below with respect to FIG. 7.

FIG. 7 illustrates an example method 700 of a computing device having a radar manager triggering a predetermined action 710 (e.g., running a script, opening an application, toggling a setting) based on a reflected RF signal. The computing device and the radar manager are similar to those illustrated in FIGS. 1 through 3 and 5 and described above, except as detailed below. Accordingly, the computing device may include one or more processors, CRM, one or more sensors, an OS, a radar system, and so forth. The radar manager may be stored as computer-readable instructions on the CRM of the computing device and may utilize the radar system to transmit a RF signal and receive a RF signal reflection.

As illustrated, the method 700 of FIG. 7 is similar to the method 600 of FIG. 6, except as detailed below. Whereas the method 600 detailed an initialization process for a radar manager of a computing device that a user may experience to generate a LUT of previous object embeddings, the method 700 details a real-time object embedding comparison. The method 700 may be performed by the radar manager, the computing device, and components thereof, in a passive fashion. That is, the radar manager may passively and continuously transmit transmission waveform signals without user input. The radar manager may do so by using a low-power UWB band (e.g., the fifth band 416 of FIG. 4) of the RF spectrum.

The radar manager, by passively transmitting a transmission waveform signal, may passively receive a reflection waveform signal that includes a version of the transmission waveform signal that is reflected by an object 702. As an example, the object 702 can be a front door of a user's home. Further, the user may have a smart home application that facilitates communication between the computing device and smart home devices (e.g., a security system, an automatic dead bolt lock). The user may have, during the radar manager initialization process described with respect to FIG. 6, programmed the smart home application to arm the security system and lock the automatic dead bolt lock based on an object embedding match determined by the radar manager.

FIG. 7 further illustrates data 704, which may include the reflection waveform signal that is reflected off the object 702. The radar manager may sample a portion of the data 704 to correlate it to the transmission waveform signal, which is known and coded (e.g., includes known pulses of known frequencies and amplitudes). The correlation can produce a CIR for the object 702 based on the data 704. As illustrated, the radar manager may pass the data 704 to the preprocessor 606, which may utilize log-scaling to improve a dynamic range of the CIR. The preprocessor 606 may also apply noise reduction or signal amplification techniques to the data 704.

The radar manager utilizes an embedder 608 to generate, based on the preprocessed data 704, an object embedding associated with the object 702. The embedder 608 may utilize an embedding model that is generated offline by an embedding network or other appropriate neural network (e.g., an L2 neural network). The embedding network may be trained on various object embeddings or CIRs as input data and, based on a cost function, generate the embedding model as output data. Further, the embedder 608 may generate the object embedding as an embedding vector that is a rotationally invariant, numerical representation of the object embedding or associated CIR. The embedder 608 may generate, based on the cost function of the embedding model, the object embedding associated with object so that the object embedding is grouped with similar object embeddings and placed far from dissimilar object embedding in an embedding space.

As illustrated in FIG. 7, the radar manager provides the object embedding from the embedder 608 to a processor 610. The processor 610 may further post-process the object embedding to minimize a translation of the object embedding or make the object embedding rotationally invariant. The radar manager may, at 708, test for match of the object embedding associated with the object 702 to an object embedding included in a LUT 612. The LUT 612 may include a library or other appropriate list of previous object embeddings associated with previous objects that a user may have scanned during the initialization process. If the radar manager determines that the object embedding is a match with one of the previous object embeddings included in the LUT 612, then the radar manager may communicate the determination (e.g., to a computing device) to trigger (e.g., by the computing device) a contextual event.

As an example, a user may scan a pair of running shoes, either standalone or on the user's feet, to produce an object embedding associated with the running shoes. The radar manager may determine that, based on the comparison to the LUT 612, that the object embedding matches a previous object embedding associated with the pair of running shoes. Again, the user may have scanned the pair of shoes during an initialization process, like that described with respect to FIG. 6. The radar manager may communicate the determination to the computing device, which may then trigger a fitness application to open or begin tracking a workout. In this example, the determination is a match between the object embedding of the running shoes and the previous object embedding of the running shows, and the contextual event includes opening the fitness application.

As another example, the user may scan his hand, which can include a watch or a wedding ring, to trigger altering a permission (e.g., authenticate, unlock) to a high-rights resource (e.g., financial account, password manager) associated with the computing device. The reflection waveform signal that is a part of the scanning may include a portions of the transmission waveform signal that is reflected off the hand, the watch or ring, or both. The financial account or other high-rights resource may require two-factor authentication (2FA). The method 700 of scanning the hand may serve as one of the two factors of the 2FA. Another factor of the 2FA may be a contemporaneous biometric authentication (e.g., fingerprint authentication, facial identification) performed by the computing device. Additionally or alternatively, the radar manager may perform the method 700 responsive to the computing device being in an unlocked state but the financial account or other high-rights resource being in a locked state.

As yet additional examples, the user may scan a smartwatch to trigger a contextual event that includes transferring contents of the smartwatch to a display of a computing device. The user may scan any one of a variety of skeuomorphic print outs (e.g., a toy that looks like a cloud), to open a weather application on a computing device. Another print out may include a toy that looks like a letter to open an email application on a computing device.

Alternatively, the radar manager may determine that the object embedding associated with the object 702 does not match a previous object embedding included in the LUT 612. The non-match may include a tolerance (e.g., a percentage) based on a Euclidean, or L2, distance between the object embedding and the previous object embedding. The radar manager may communicate the determination to a computing device, which may provide an error message 712 to a user of the computing device.

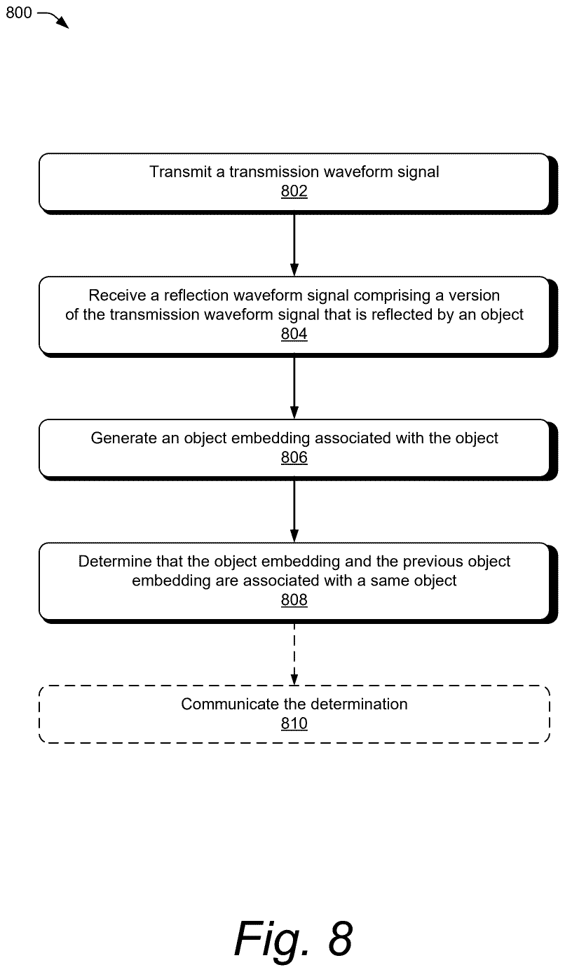

FIG. 8 illustrates an example method 800 for decoding RF signal reflections into object embeddings for contextual triggers. In aspects, a computing device includes a radar manager and a radar system. The radar system may include one or more antenna elements respectively coupled to a transceiver that includes one or more transmit or receive channels. The radar manager may perform the method 800 by utilizing the radar system, and other components not described, of the computing device.

At 802, the radar manager transmits a transmission waveform signal. The radar manager may utilize a transmit antenna of one or more antenna elements and a respective transmit channel of the transceiver. The transmission waveform signal may be a temporally constrained UWB RF signal so that transmitting the transmission waveform signal does not require a long duration of time (e.g., 1 second(s), 2 s, 5 s). Further, the transmission waveform signal may be coded to include various pules of a specific frequency or multiple frequencies centered around a center frequency. The transmission waveform signal may be a short-range, low-power signal so that battery drain may be minimized for the computing device. Additionally, the lower-power signal may be difficult to detect by other devices or users, making the method 800 secure.

At 804, the radar manager receives a reflection waveform signal that includes a version of the transmission waveform signal that is reflected by an object. The object may include a surface and a sub-surface. The reflection waveform signal may include a version of the transmission waveform signal that is reflected off the surface, the sub-surface, or both of the object. The object may be any one of a variety of personal objects (e.g., pets, toys, possessions), commercial objects (e.g., cash registers, fuel pumps), body parts (e.g., hands, feet), or another object. Further, the object may include a first object and a second object (e.g., a hand and a wedding ring, a hand and a smartwatch) and the reflection waveform signal can include versions of the transmission waveform signal that are reflected by the first object, the second object, or both.

At 806, the radar manager generates an object embedding associated with the object. As described above, the object embedding may be based on an embedding model generated by training an embedding network offline. The object embedding may be a rotationally invariant, numerical representation of the reflection waveform signal. Additionally or alternatively, the object embedding may be a physical transformation (e.g., translation, rotation) of data associated with the reflection waveform signal.

At 808, the radar manager determines that the object embedding and the previous object embedding are associated with a same object. For example, the radar manager may make the determination based on a tolerance (e.g., percentage, statistical significance) between the object embedding and the previous object embedding. The radar manager may make the comparison between the object embedding and the previous object embedding by comparing rotationally invariant, numerical representations of the object embeddings to each other.

Optionally at 810, the radar manager communicates the determination. The radar manager may communicate the determination to a computing device via an application programming interface (API) or by being integrated into an OS of the computing device. A computing device may trigger, based on receiving the communication of the determination, a contextual event. Various examples of contextual events include opening a fitness app after scanning a pair of running shoes, starting a car after scanning a car key, locking a smart lock when scanning a door, opening a clock application after scanning a watch, and so forth. By performing the method 800 illustrated in FIG. 8, the radar manager is effective to decode RF signal reflections into object embeddings for contextual triggers.

### ADDITIONAL EXAMPLES

In the following section, additional examples are provided.

Example 1: A method comprising: transmitting a transmission waveform signal; receiving a reflection waveform signal, the received reflection waveform signal comprising a version of the transmission waveform signal that is reflected by an object; generating, based on the reflection waveform signal, an object embedding associated with the object; comparing the object embedding to a previous object embedding to provide a comparison result; and determining, based on the comparison result, that the object embedding and the previous object embedding are associated with a same object.

Example 2: The method of example 1, wherein at least one of: the transmission waveform signal is fixed; the transmission waveform signal is a high bandwidth signal of up to 500 megahertz (MHz); the transmission waveform signal is temporally constrained; or the transmission waveform signal comprises radio waves of frequencies from 3.1 gigahertz (GHz) to 10.5 GHz.

Example 3: The method of example 1 or 2, wherein the object is at least one of: a personal object; a commercial object; or a body part.

Example 4: The method of any one of the preceding examples, further comprising: communicating the determination that the object embedding and the previous object embedding are associated with the same object; receiving, by a computing device, the determination; and triggering, by the computing device and based on the determination, a predetermined action.

Example 5: The method of example 4, wherein: the contextual event includes altering a permission to a high-rights resource associated with the computing device; the high-rights resource requiring two factor authentication; the method provides one of two factors of the two factor authentication; and the method is performed responsive to the computing device being in an unlocked state but the high-rights resource being in a locked state.

Example 6: The method of example 5, wherein another of the two factors of the two factor authentication is a contemporaneous biometric authentication performed by the computing device.

Example 7: The method of any one of the preceding examples, wherein: the object embedding is based on an embedding model generated by training an embedding neural network offline; and at least one of: the object embedding is a rotationally invariant, numerical representation of the reflection waveform signal; or the object embedding is a physical transformation of data associated with the reflection waveform signal.

Example 8: The method of any one of the preceding examples, wherein: the object embedding is a numerical representation of features of the object; the previous object embedding is a previous numerical representation of features of a previous object; and comparing the object embedding to the previous object embedding compares the numerical representation to the previous numerical representation.

Example 9: The method of any one of the preceding examples, wherein: the object has a surface and a sub-surface; and at least one of: the reflection waveform signal comprises a version of the transmission waveform signal that is reflected by the surface of the object; or the reflection waveform signal comprises a version of the transmission waveform signal that is reflected by the sub surface of the object.

Example 10: The method of any one of the preceding examples, wherein generating the object embedding further comprises: sampling a portion of the reflection waveform signal; correlating the portion of the reflection waveform signal with the transmission waveform signal; generating, based on the correlation, a channel impulse response associated with the portion of the reflection waveform signal; and storing the channel impulse response as the object embedding.

Example 11: The method of example 10, wherein generating the object embedding further comprises: converting, using an embedding network, the channel impulse response into an embedding vector; and storing the embedding vector as the object embedding.

Example 12: The method of example 11, further comprising: providing reflection waveform signals of various objects as input data to the embedding network; determining, by the embedding network, various object embeddings in an embedding space as output data; determining, by the embedding network and based on the various object embeddings, a cost function associated with the various object embeddings; and grouping, by the embedding network and based on the cost function, similar objects in the embedding space.

Example 13: The method of any one of the preceding examples, wherein: the object comprises a first object and a second object; and at least one of: the reflection waveform signal comprises a version of the transmission waveform signal that is reflected by the first object; or the reflection waveform signal comprises a version of the transmission waveform signal that is reflected by the second object.

Example 14: The method of any one of the preceding examples, wherein: the object is at least partially occluded by another object; the transmission waveform signal penetrates the another object; and the reflection waveform signal penetrates the another object.

Example 15: A computing device comprising: a radar system comprising: an antenna array; and a transceiver comprising: at least one transmit channel respectively coupled to antenna elements of the antenna array; and at least one receive channel respectively coupled to antenna elements of the antenna array; at least one processor; and computer readable media storing instructions that, when executed by the at least one processor, cause the at least one processor to implement a radar manager utilizing the antenna array and the transceiver by performing the method of any one of examples 1-14.

Example 16: Computer readable media comprising instructions that, when executed by at least one processor, cause the at least one processor to perform the method of any one of examples 1-14.

### Conclusion

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying Drawings and terms discussed herein may be indicative of one or more items or terms, and thus reference may be made interchangeably to single or plural forms of the items and terms in this written description.

Although implementations of systems and techniques of, and apparatuses enabling, decoding RF signal reflections into object embeddings for contextual triggers have been described in language specific to certain features and/or methods, the subject of the appended Claims is not necessarily limited to the specific features or methods described. Rather, the specific features and methods are disclosed as example implementations of decoding RF signal reflections into object embeddings for contextual triggers.

1. A method comprising:
transmitting a transmission waveform signal;
receiving a reflection waveform signal, the received reflection waveform signal comprising a version of the transmission waveform signal that is reflected by an object;
generating, by a neural network and based on the reflection waveform signal, an object embedding vector in an embedding space, the object embedding vector associated with the object;
comparing, by the neural network, the object embedding vector to a plurality of embedding vectors associated with objects previously embedded by the neural network to provide a comparison result; and
determining, based on the comparison result, that the object embedding vector and one of the previous embedding vectors associated with the objects previously embedded by the neural network are associated with a same object.

2. The method of claim 1, wherein at least one of:
the transmission waveform signal is fixed;
the transmission waveform signal is a high-bandwidth signal of up to 500 megahertz (MHz);
the transmission waveform signal is temporally constrained; or
the transmission waveform signal comprises radio waves of frequencies from 3.1 gigahertz (GHz) to 10.5 GHz.

3. The method of claim 1, further comprising:
identifying, based on the comparison result, the object; and
wherein the object is at least one of:
a personal object;
a commercial object; or
a body part.

4. The method of claim 1, further comprising:
communicating the determination that the object embedding vector and the one of the plurality of embedding vectors associated with the objects previously embedded by the neural network are associated with the same object;
receiving, by a computing device, the determination; and
triggering, by the computing device and based on the determination, a predetermined action.

5. The method of claim 4, wherein:
the contextual event includes altering a permission to a high-rights resource associated with the computing device;
the financial account or other high-rights resource requiring two-factor authentication;
the method provides one of two factors of the two-factor authentication; and
the method is performed responsive to the computing device being in an unlocked state but the high-rights resource being in a locked state.

6. The method of claim 5, wherein another of the two factors of the two-factor authentication is a contemporaneous biometric authentication performed by the computing device.

7. The method of claim 1, wherein
the object embedding vector is based on an embedding model generated by an offline training of the neural network, the offline training comprising:
transmitting a training transmission waveform signal;
receiving a training reflection waveform signal, the received training reflection waveform signal comprising a version of the training transmission waveform signal that is reflected by a training object;
generating, by the neural network and based on the training reflection waveform signal, a training object embedding vector in the embedding space, the training object embedding vector associated with the training object; and
storing the training object embedding vector and an association of the training object.

8. The method of claim 1, wherein:
the object embedding vector is a numerical representation of features of the object;
the plurality of embedding vectors associated with the objects previously embedded by the neural network is a plurality of previous numerical representations of features of the objects previously embedded by the neural network; and
comparing the object embedding vector to the plurality of embedding vectors associated with the objects previously embedded by the neural network compares the numerical representation to the plurality of previous numerical representations.

9. The method of claim 1, wherein:
the object has a surface and a sub-surface; and at least one of:
the reflection waveform signal comprises a version of the transmission waveform signal that is reflected by the surface of the object; or
the reflection waveform signal comprises a version of the transmission waveform signal that is reflected by the sub-surface of the object.

10. The method of claim 1, wherein generating the object embedding vector further comprises:
sampling a portion of the reflection waveform signal;
correlating the portion of the reflection waveform signal with the transmission waveform signal;
generating, based on the correlation, a channel impulse response associated with the portion of the reflection waveform signal; and
storing the channel impulse response as the object embedding vector.

11. The method of claim 10, wherein generating the object embedding vector further comprises:
converting, using an embedding network, the channel impulse response into an embedding vector; and
storing the embedding vector as the object embedding vector.

12. The method of claim 11, further comprising:
providing reflection waveform signals of various objects as input data to the embedding network;
determining, by the embedding network, various object embedding vectors in an embedding space as output data;
determining, by the embedding network and based on the various object embedding vectors, a cost function associated with the various object embedding vectors; and
grouping, by the embedding network and based on the cost function, similar objects in the embedding space.

13. The method of claim 1, wherein:
the object comprises a first object and a second object; and at least one of:
the reflection waveform signal comprises a version of the transmission waveform signal that is reflected by the first object; or
the reflection waveform signal comprises a version of the transmission waveform signal that is reflected by the second object.

14. The method of claim 1, wherein:
the object is at least partially occluded by another object;
the transmission waveform signal penetrates the another object; and
the reflection waveform signal penetrates the another object.

15. A computing device comprising:
a radar system comprising:
an antenna array; and
a transceiver comprising:
at least one transmit channel respectively coupled to antenna elements of the antenna array; and
at least one receive channel respectively coupled to antenna elements of the antenna array;
at least one processor; and
computer-readable media storing instructions that, when executed by the at least one processor, cause the at least one processor to:
transmit, by the transceiver, a transmission waveform signal;
receive, by the transceiver, a reflection waveform signal, the received reflection waveform signal comprising a version of the transmission waveform signal that is reflected by an object;
generate, by a neural network and based on the reflection waveform signal, an object embedding vector in an embedding space, the object embedding vector associated with the object;
compare, by the neural network, the object embedding vector to a plurality of embedding vectors associated with objects previously embedded by the neural network to provide a comparison result; and
determine, based on the comparison result, that the object embedding vector and one of the plurality of embedding vectors associated with objects previously embedded by the neural network are associated with a same object.

16. A computer-readable media comprising instructions that, when executed by at least one processor, cause the at least one processor to:
transmit, by a transceiver, a transmission waveform signal;
receive, by the transceiver, a reflection waveform signal, the received reflection waveform signal comprising a version of the transmission waveform signal that is reflected by an object;
generate, by a neural network and based on the reflection waveform signal, an object embedding vector in an embedding space the object embedding vector associated with the object;
compare, by the neural network, the object embedding vector to a plurality of embedding vectors associated with objects previously embedded by the neural network to provide a comparison result; and
determine, based on the comparison result, that the object embedding vector and one of the plurality of embedding vectors associated with objects previously embedded by the neural network are associated with a same object.

17. The computing device of claim 15, wherein the object embedding vector is based on an embedding model generated by an offline training of the neural network, the offline training comprising:
transmitting, by a training device, a training transmission waveform signal;
receiving, by the training device, a training reflection waveform signal, the received training reflection waveform signal comprising a version of the training transmission waveform signal that is reflected by a training object;
generating, by the neural network and based on the training reflection waveform signal, a training object embedding vector in the embedding space, the training object embedding vector associated with the training object; and
storing, in the computer-readable media, the training object embedding vector and an association of the training object.

18. The computing device of claim 15, wherein the instructions further cause the at least one processor to, responsive to the determination that the object embedding vector and the one of the plurality of object embedding vectors are associated with the same object, trigger a predetermined action.

19. The computer-readable media of claim 16, wherein the object embedding vector is based on an embedding model generated by an offline training of the neural network, the offline training comprising:
transmitting, by a training device, a training transmission waveform signal;
receiving, by the training device, a training reflection waveform signal, the received training reflection waveform signal comprising a version of the training transmission waveform signal that is reflected by a training object;
generating, by the neural network and based on the training reflection waveform signal, a training object embedding vector in the embedding space, the training object embedding vector associated with the training object; and
storing, in the computer-readable media, the training object embedding vector and an association of the training object.

20. The computer-readable media of claim 16, wherein the instructions further cause the at least one processor to, responsive to the determination that the object embedding vector and the one of the plurality of object embedding vectors are associated with the same object, trigger a predetermined action.
